(19) United States
(12) Patent Application Publication
(10) Pub. No.: US 2025/0182743 A1
(43) Pub. Date: Jun. 5, 2025

(54) METHOD, APPARATUS, COMPUTER-READABLE MEDIUM, AND ELECTRONIC DEVICE FOR SPEECH RECOGNITION

(71) Applicant: Beijing Youzhuju Network Technology Co., Ltd., Beijing (CN)

(72) Inventors: Yizhou Lu, Beijing (CN); Zejun Ma, Beijing (CN)

(21) Appl. No.: 18/843,683

(22) PCT Filed: Mar. 1, 2023
(86) PCT No.: PCT/CN2023/079156

§ 371 Date: Sep. 3, 2024

(30) Foreign Application Priority Data
Mar. 3, 2022 (CN) 202210204891.7

(51) Int. Cl. G10L 15/06; G10L 15/18; G10L 15/183

(52) U.S. Cl. CPC G10L 15/063; G10L 15/1815; G10L 15/183

(57) ABSTRACT

A method of speech recognition, an apparatus for speech recognition, a computer-readable medium, an electronic device, a computer program product, and a computer program. The method includes: obtaining a target speech signal comprising a plurality of languages to be recognized; recognizing semantics of the target speech signal through a speech recognition model fusing sparse sub-networks of various languages; and the sparse sub-network being obtained by performing a parameter-pruning processing on a multi-language pre-trained model, the multi-language pre-trained model being obtained by training based on a speech signal comprising the plurality of languages.

This application is the U.S. National Stage of International Application No. PCT/CN2023/079156, filed on Mar. 1, 2023, which claims priority to Chinese Patent Application No. 202210204891.7, filed with the Chinese Patent Office on Mar. 3, 2022, and entitled “METHOD, APPARATUS, COMPUTER-READABLE MEDIUM, AND ELECTRONIC DEVICE FOR SPEECH RECOGNITION”, which are incorporated herein by reference in their entireties.

### FIELD

The present disclosure relates the computer technology neighborhood and, specifically, to a method of speech recognition, an apparatus for speech recognition, a computer-readable medium, an electronic device, a computer program product, and a computer program.

### BACKGROUND

Current cross-language representation learning methods do not consider the diversity of pronunciation between different languages, and still follow the model structure of monolingual representation learning. The model does not have a module dedicated to modeling specific language characteristics, and thus often faces the problem of inter-language interference. This problem is more serious when the number of languages and unsupervised data increase. When this multi-language pre-trained model is used in the downstream multi-language speech recognition task, it will lead to a significant degradation of the recognition performance of major languages (e.g., Chinese, English), which is much larger than that of the monolingual pre-trained model.

### SUMMARY

This summary is provided to introduce the concepts in a simplified form that are further described below in the detailed description. The content section is not intended to identify key features or essential features of the claimed subject matter, nor is it intended to be used to limit the scope of the claimed subject matter.

In a first aspect, the present disclosure provides a method of speech recognition, comprising: obtaining a target speech signal comprising a plurality of languages to be recognized; recognizing semantics of the target speech signal through a speech recognition model fusing sparse sub-networks of various languages; and the sparse sub-network being obtained by performing a parameter-pruning processing on a multi-language pre-trained model, the multi-language pre-trained model being obtained by training based on a speech signal comprising the plurality of languages.

In a second aspect, the present disclosure provides an apparatus for speech recognition, comprising: an obtaining module configured to obtain a target speech signal comprising a plurality of languages to be recognized; a recognizing module configured to recognize semantics of the target speech signal through a speech recognition model fusing sparse sub-networks of various languages; and the sparse sub-network being obtained by performing a parameter-pruning processing on a multi-language pre-trained model, the multi-language pre-trained model being obtained by training based on a speech signal comprising the plurality of languages.

In a third aspect, the present disclosure provides a computer-readable medium having a computer program stored thereon, wherein the computer program, when executed by a processor, implements the steps of the method of speech recognition.

In a fourth aspect, the present disclosure provides an electronic device, comprising: a memory having a computer program stored thereon; and a processor for executing the computer program in the memory to implement the steps of the method of speech recognition.

In a fifth aspect, an embodiment of the present disclosure further provides a computer program product comprising a computer program carried on a computer-readable medium, program code comprised in the computer program being for implementing the steps of in the first aspect.

In a sixth aspect, an embodiment of the present disclosure further provides a computer program, which, when executed by a processor, implements the steps in the first aspect.

### BRIEF DESCRIPTION OF THE DRAWINGS

The above and other features, advantages, and aspects of various embodiments of the present disclosure will become more apparent with reference to the following detailed description taken in conjunction with the accompanying drawings. The same or like reference numerals represent the same or like elements throughout the drawings, it being understood that the drawings are illustrative and that the elements and primaries are not necessarily drawn to scale. In the drawings:

FIG. 1 is a schematic structural diagram of a computer system according to an example embodiment of the present disclosure.

FIG. 2 is a flowchart of a method of speech recognition according to an example embodiment of the present disclosure.

FIG. 3 is a flowchart of a method of training a speech recognition model according to an example embodiment of the present disclosure.

FIG. 4 is a flowchart of a sub-step of step S202 according to an example embodiment of the present disclosure.

FIG. 5 is a block diagram of an apparatus for speech recognition according to an example embodiment of the present disclosure.

FIG. 6 is a schematic structural diagram of an electronic device according to an example embodiment of the present disclosure.

### DESCRIPTION OF THE ACCOMPANYING REFERENCE NUMBERS

120—terminal; 140—server; 20—apparatus for speech recognition; 201—obtaining module; 203—recognizing module; 205—processing module; 600—electronic device; 601—processor; 602—ROM; 603—RAM; 604—bus; 605—I/O interface; 606—input device; 607—output device; 608—memory; 609—communication device.

### DETAILED DESCRIPTION

Embodiments of the present disclosure will be described in more detail below with reference to the accompanying drawings. Although certain embodiments of the present disclosure are shown in the drawings, it should be understood that the present disclosure may be implemented in various forms and should not be construed as being limited to the embodiments set forth herein, but rather these embodiments are provided for a thorough and complete understanding of the present disclosure. It should be understood that the drawings and embodiments of the present disclosure are only for illustrative purposes and are not intended to limit the scope of the present disclosure.

It should be understood that the steps recorded in the method embodiments of the present disclosure may be executed in different orders, and/or executed in parallel. Furthermore, method embodiments may comprise additional steps and/or omit the steps illustrated performing. The scope of the present disclosure is not limited in this respect.

The term ‘comprising’ and variations thereof, as used herein, is inclusive, i. e., ‘comprising but not limited to.’ The term ‘based on’ is ‘based at least in part on’. The term ‘one embodiment’ means ‘at least one embodiment’.

It should be noted that the modifications of ‘a’ and ‘a plurality’ mentioned in the present disclosure are illustrative rather than restrictive, and those skilled in the art should understand that they should be understood as ‘one or more’ unless the context clearly indicates otherwise.

The names of messages or information interacted between a plurality of devices in the embodiments of the present disclosure are only for illustrative purposes and are not intended to limit the scope of these messages or information.

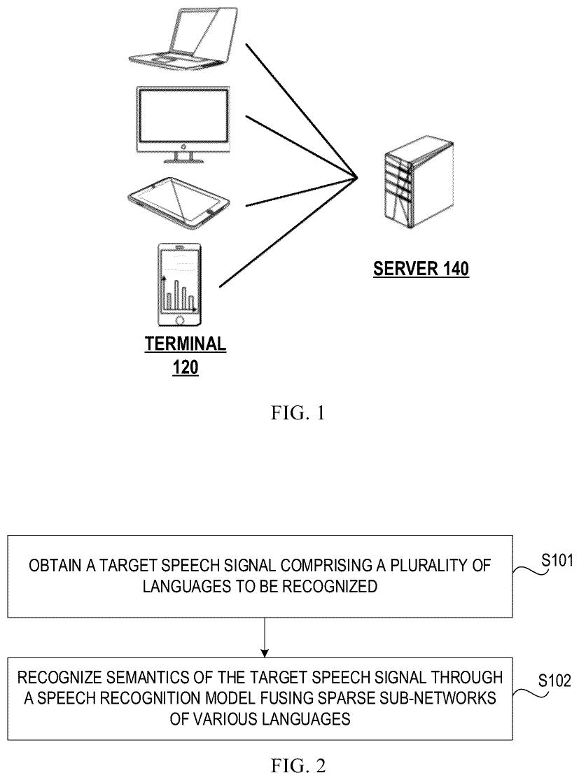

FIG. 1 is a schematic structural diagram of a computer system according to an example embodiment of the present disclosure. The computer system comprises a terminal 120 and a server 140.

The terminal 120 and the server 140 are connected to each other through a wired or wireless network.

The terminal 120 may comprise at least one of a smartphone, a notebook computer, a desktop computer, a tablet computer, a smart phone box, and a smart robot.

The terminal 120 comprises a display; the display may be used to display a speech recognition result.

The terminal 120 comprises a first memory and a first processor, where the first memory stores a first program, and the first program is invoked and executed by the first processor to implement the method of speech recognition provided in the present disclosure. The first memory may comprise, but is not limited to, Random Access Memory (RAM), Read Only Memory (ROM), Programmable Read-Only Memory (PROM), Erasable Programmable Read-Only Memory (EPROM), and Electrically Erasable Programmable Read-Only Memory (EEPROM).

The first processor may be composed of one or more integrated circuit chips. Optionally, the first processor may be a general-purpose processor, such as, for example, a Central Processing Unit (CPU) or a Network Processor (NP). As an example, the speech recognition model in the terminal may be obtained by training of the terminal; or, trained by the server and obtained by the terminal from the server.

The server 140 comprises a second memory and a second processor, where the second memory stores a second program, and the second program is invoked by the second processor to implement the speech identification method provided in the present disclosure. As an example, a speech recognition model is stored in the second memory, and the speech recognition model is invoked by the second processor to implement a method of speech recognition. Optionally, the second memory may comprise, but is not limited to, the following: a RAM, a ROM, a PROM, an EPROM, and an EEPROM. Optionally, the second processor may be a general-purpose processor, such as a CPU or an NP.

The server may be an independent physical server, may also be a server cluster or a distributed system composed of a plurality of physical servers, and may also be a cloud server providing basic cloud computing services such as cloud services, cloud databases, cloud computing, cloud functions, cloud storage, network services, cloud communications, middleware services, domain name services, security services, content delivery networks (CDNs), and big data and artificial intelligence platforms. The terminal may be, but is not limited to, a smartphone, a tablet computer, a notebook computer, a desktop computer, a smart speaker, a smart watch, and the like. The terminal and the server may be directly or indirectly connected in a wired or wireless communication manner, which is not limited in the present disclosure.

In recent years, the rapid development of pre-trained language models and the number of pre-trained language model parameters have been increasing, leading to higher computational costs. In order to improve the efficiency of pre-trained language models, various model compression methods have been proposed, comprising model pruning.

Based on this, the present disclosure provides a method of speech recognition provided by an example embodiment, comprising: obtaining a target speech signal comprising a plurality of languages to be recognized; recognizing semantics of the target speech signal through a speech recognition model fusing sparse sub-networks of various languages; and the sparse sub-network being obtained by performing a parameter-pruning processing on a multi-language pre-trained model, the multi-language pre-trained model being obtained by training based on a speech signal comprising the plurality of languages. The multiple languages comprise some major languages, such as Chinese, English, etc., as well as comprise some minor languages, such as French, Spanish, etc. The present disclosure addresses the language interference problem of cross-language representation learning from an adaptive perspective, where the entire multi-language pre-training model performs parameter-pruning processing on different languages, and constructs a set of sparse sub-networks sharing some of the parameters to be trained, thus endowing the speech recognition model with the ability to model for the specificity of different languages, and providing substantial improvement for both large and minor languages in the process of cross-language representation learning.

By means of the technical solution, a target speech signal comprising a plurality of languages to be recognized is obtained; semantics of the target speech signal is recognized through a speech recognition model fusing sparse sub-networks of various languages; and the sparse sub-network is obtained by performing a parameter-pruning processing on a multi-language pre-trained model, and the multi-language pre-trained model is obtained by training based on a speech signal comprising the plurality of languages.

Additional features and advantages of the disclosure will be set forth in the detailed description which follows.

It should be noted that, the method of speech recognition provided in this embodiment is described in detail in the following. Reference may be made to the following description of FIG. 2 for a part that is not mentioned herein, and details are not repeatedly described herein.

Please refer to FIG. 2, FIG. 2 is a flowchart of a method of speech recognition according to an example embodiment of the present disclosure. The method is executed by an electronic device, for example, by a terminal or server in the computer system shown in FIG. 1. The method of speech recognition shown in FIG. 2 comprises the following steps:

At step S101, a target speech signal comprising a plurality of languages to be recognized is obtained.

It should be noted that the plurality of languages comprise some major languages, such as Chinese and English, and some minor languages, such as French and Spanish.

At step S102, semantics of the target speech signal are recognized through a speech recognition model fusing sparse sub-networks of various languages.

The sparse sub-network is obtained by performing a parameter-pruning processing on a multi-language pre-trained model, and the multi-language pre-trained model is obtained by training based on a speech signal comprising the plurality of languages.

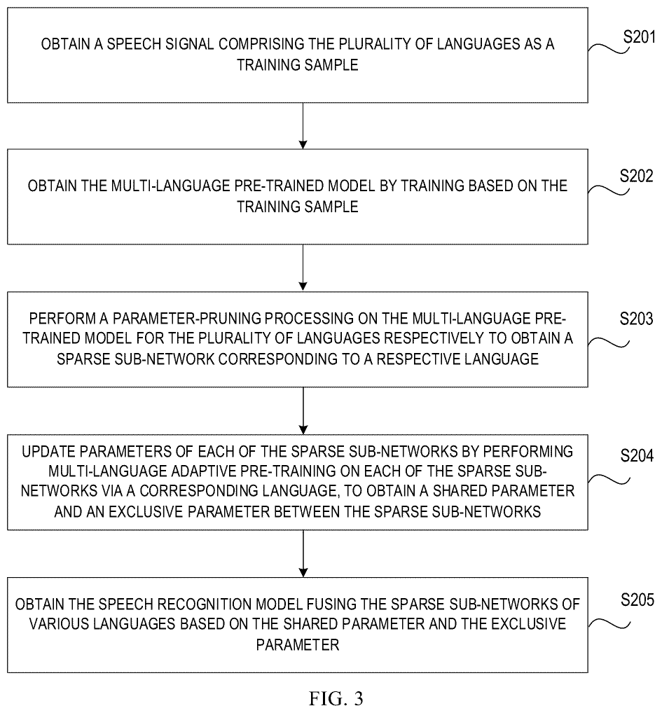

Please refer to FIG. 3, FIG. 3 is a flowchart of a method of training a speech recognition model according to an example embodiment of the present disclosure. The method of training a speech recognition model comprises the following steps.

At step S201, a speech signal comprising the plurality of languages is obtained as a training sample.

It should be noted that the plurality of languages comprise some major languages, such as Chinese and English, and some minor languages, such as French and Spanish. The number of samples of the major language is far greater than the number of samples of the minor language, for example, the number of samples of the major language may be 1,000,000, while the number of samples of the minor language may be only tens of thousands. Moreover, the training samples are unsupervised speech data, i. e., speech data without manual annotation.

At step S202, the multi-language pre-trained model is obtained by training based on the training sample.

It should be noted that the multi-language pre-trained model is used for speech recognition, and the multi-language pre-trained model can recognize different languages.

In the training stage, the Wav2vec 2.0 framework is used for cross-language speech representation learning, which mainly comprises a feature extractor, a context network and a quantization module. The feature extractor consists of a multi-layer convolutional neural network; the context network consists of multi-layer Transformer layers, which is used to semantically learn the output speech signal from the feature extractor, and outputs the representation vector with contextual information; and the quantization module is used to provide the original unsupervised speech data, which is used for the comparative learning, and the output speech signal from the feature extractor are quantized. For the stability of speech representation learning, the diversity loss is additionally added to promote the use of the quantization module by the multi-language pre-trained model and to avoid the collapse phenomenon of the quantization module.

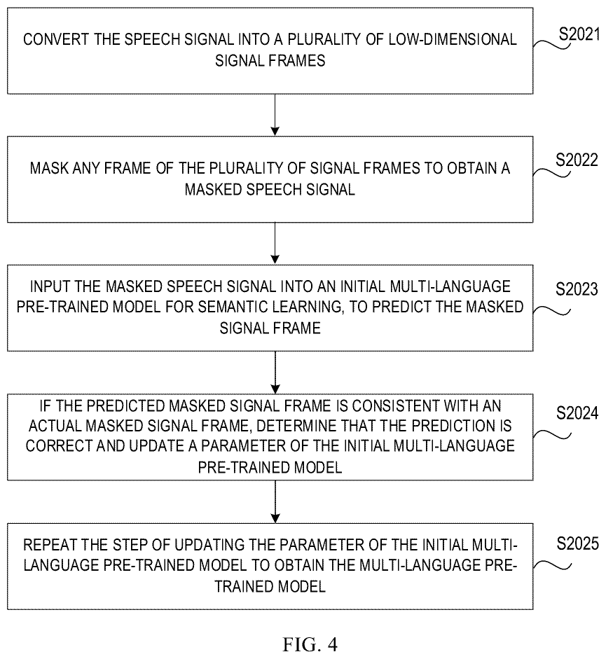

It should be noted that, step S202 comprises sub-step S2021, sub-step S2022, sub-step S2023, sub-step S2024, and sub-step S2025, and a specific manner of obtaining the multi-language pre-trained model through training is described in detail in the sub-steps of step S202. Please refer to FIG. 4, FIG. 4 is a flowchart of sub-steps of step S202 according to an example embodiment of the present disclosure.

At sub-step S2021, the speech signal is converted into a plurality of low-dimensional signal frames.

It should be noted that, before converting the speech signal into a plurality of low-dimensional signal frames, up-sampling is performed on a training sample in a language with the number of samples less than a first threshold, to expand, in the sampled data, the number of training samples in the language with the number of samples less than the first threshold. For example, the number of samples in a minor language may be only tens of thousands, so up-sampling need to be performed on training samples of the minor language. Uniform sampling is performed on a language with the number of samples higher than a second threshold, for example, the number of samples for a major language can be 1 million, and then only a uniform sampling is needed to get enough sample data.

The input speech signal is converted into a plurality of low-dimensional signal frames by the previously mentioned feature extractor, wherein each signal frame is a speech representation signal with a fixed duration. By way of example, each signal frame may be about 25 ms long with a step size of 20 ms.

At sub-step S2022, any frame of the plurality of signal frames is masked to obtain a masked speech signal.

By way of example, a certain speech signal is divided into a total of 10 frames, then any one or two of the 10 signal frames may be masked, and if a certain speech signal is divided into a total of 100 frames, then any 10 or 20 of the 100 signal frames may be masked, and then the masked speech signal is obtained.

At sub-step S2023, the masked speech signal is inputted into an initial multi-language pre-trained model for semantic learning, to predict the masked signal frame.

With the aforementioned context network, the masked speech signal is semantically learned, and the masked signal frame is reconstructed based on the result of the semantic learning, in order to predict the masked speech signal, and at the same time, the quantization module receives the output of the feature extractor as an unmasked speech signal, so that it can compare the predicted masked speech signal with the unsupervised speech data that is used by the quantization module to provide the masked speech signal.

At sub-step S2024, if the predicted masked signal frame is consistent with an actual masked signal frame, it is determined that the prediction is correct and updating a parameter of the initial multi-language pre-trained model.

If the predicted masked signal frame is consistent with an actual masked signal frame output by the quantization module, it is determined that the signal frame predicted by the context network is correct, and a parameter of the initial multi-language pre-trained model is updated.

At sub-step S2025, the step of updating the parameter of the initial multi-language pre-trained model is repeated to obtain the multi-language pre-trained model.

Repeating sub-steps S2022-S2024, the masked speech signal frames are not repeated each time, and then semantically learning the masked speech signal through the context network to predict the masked signal frames, comparing the predicted masked signal frames with the actual masked signal frames outputted by the quantization module, and determining that the predicted signal frame predicted by the context network is correct when the comparison is consistent, and updating the parameter of the initial multi-language pre-trained model to obtain the multi-language pre-trained model.

By way of example, sub-steps S2022-S2024 may be repeated a predetermined number of times, which may be a predetermined proportion of the number of signal frames of the speech signal, such as 50% of the frames of 10 signals, which is 5 times, and the predetermined number of times may be obtained on the basis of human experience or according to other practicable methods, which will not be further discussed herein.

At step S203, a parameter-pruning processing is performed on the multi-language pre-trained model for the plurality of languages respectively to obtain a sparse sub-network corresponding to a respective language.

It should be noted that the parameter-pruning processing mainly comprises the following two manners. A lottery assumption manner and a Taylor unfolding manner. Either of these pruning approaches may be used in the present disclosure, and the two pruning approaches are described in detail below.

The step of performing, based on a lottery assumption manner, the parameter-pruning processing on the multi-language pre-trained model for the plurality of languages respectively comprises: training the multi-language pre-trained model by using the speech signal of each language as a training sample, where the multi-language pre-trained model refers to the multi-language pre-trained model trained in step S202, in addition to the training convergence conditions here being the same as in step S202. Then obtaining all parameters of the multi-language pre-trained model corresponding to each language; constructing a parameter matrix based on the parameters. Then constructing a mask matrix corresponding to the parameter matrix, the length and width of which are consistent with the parameter matrix; then obtaining an absolute value of each parameter in the parameter matrix; cropping the parameter of a predetermined proportion based on a magnitude of the absolute value, for example, a predetermined proportion of the parameter can be cropped from small to large according to the magnitude of the absolute value, and the predetermined proportion can be 20%, 30%, or 50% and the like, and there is no restriction herein. Finally, setting a masking state of the cropped parameter at a corresponding position in the mask matrix to a first value and the masking states of the remaining positions to a second value, and in one implementation the first value is 0 and the second value is 1.

The step of performing, based on a Taylor unfolding manner, the parameter-pruning processing on the multi-language pre-trained model for the plurality of languages respectively comprises: training the multi-language pre-trained model by using the speech signal of each language as a training sample, where the multi-language pre-trained model refers to the multi-language pre-trained model obtained by the training in step S202, and furthermore the training convergence conditions herein are the same as those in step S202; obtaining all parameters of the multi-language pre-trained model corresponding to each language; predicting, after unfolding the parameters by a first-order Taylor, a loss value caused to the multi-language pre-trained model after respective parameter has been cropped, and in one embodiment, a formula for predicting a loss value caused to the multi-language pre-trained model after respective parameter has been cropped comprises:

|g²w²|

Herein, g is a gradient of the parameter, w is a weight of the parameter, and | is an operator for taking an absolute value; and then the parameters of a predetermined proportion are cropped based on a magnitude of the loss value, for example, the parameters of a predetermined proportion can be pruned from small to large according to the magnitude of the loss value, and the predetermined proportion can be 20%, 30%, or 50% and so forth, and there is no restriction herein.

The multi-language pre-trained model obtained after parameter-pruning processing can accelerate the inference calculation speed, satisfy the minimum latency limit, can reduce the memory consumed, is easier to deploy for the terminal side, such as a mobile phone, and is more convenient for model training and fine-tuning.

With any of the above two pruning methods, the multi-language pre-trained model is trained by using the speech signal of each language as a training sample to obtain a sparse sub-network corresponding to a respective language.

At step S204, parameters of each of the sparse sub-networks are updated by performing multi-language adaptive pre-training on each of the sparse sub-networks via a corresponding language, to obtain a shared parameter and an exclusive parameter between the sparse sub-networks.

In the training process, each training batch consists of training samples of only one language, where batch refers to: a small portion of the training samples is used to update the parameters of the model weights in a back-propagation, which is called a “batch of data”.

For each language, only the sparse sub-network corresponding to the language is used for forward propagation, and the sparse sub-network loss is computed, and only the parameters corresponding to this sparse sub-network are updated in backpropagation. In this way, the final sparse sub-network automatically assigns shared and exclusive parameters between different languages within the network, thus achieving the effect of adaptive training.

At step S205, the speech recognition model fusing the sparse sub-networks of various languages is obtained based on the shared parameter and the exclusive parameter.

The proposed speech recognition model based on sparse shared sub-network cross-language speech representation in this disclosure can outperform the baseline cross-language speech representation learning method on both major and minor languages. On the disclosed Common Voice data set, the proposed method of speech recognition has a relative 9.8% average phoneme error rate reduction on the 100M model compared to the baseline system, and a 7.4% phoneme error rate reduction on the 300M model. Moreover, this method can significantly alleviate the language interference problem suffered by large languages, with a relative 17.8% and 16.7% phoneme error rate reduction for large languages on the 100M model and the 300M model.

In conclusion, the present disclosure provides a method of speech recognition, comprising obtaining a target speech signal comprising a plurality of languages to be recognized; recognizing semantics of the target speech signal through a speech recognition model fusing sparse sub-networks of various languages; and the sparse sub-network being obtained by performing a parameter-pruning processing on a multi-language pre-trained model, the multi-language pre-trained model being obtained by training based on a speech signal comprising the plurality of languages. The present disclosure addresses the language interference problem of cross-language representation learning from an adaptive perspective, where the entire multi-language pre-training model performs parameter-pruning processing on different languages, and constructs a set of sparse sub-networks sharing some of the parameters to be trained, thus endowing the speech recognition model with the ability to model for the specificity of different languages, and providing substantial improvement for both large and minor languages in the process of cross-language representation learning.

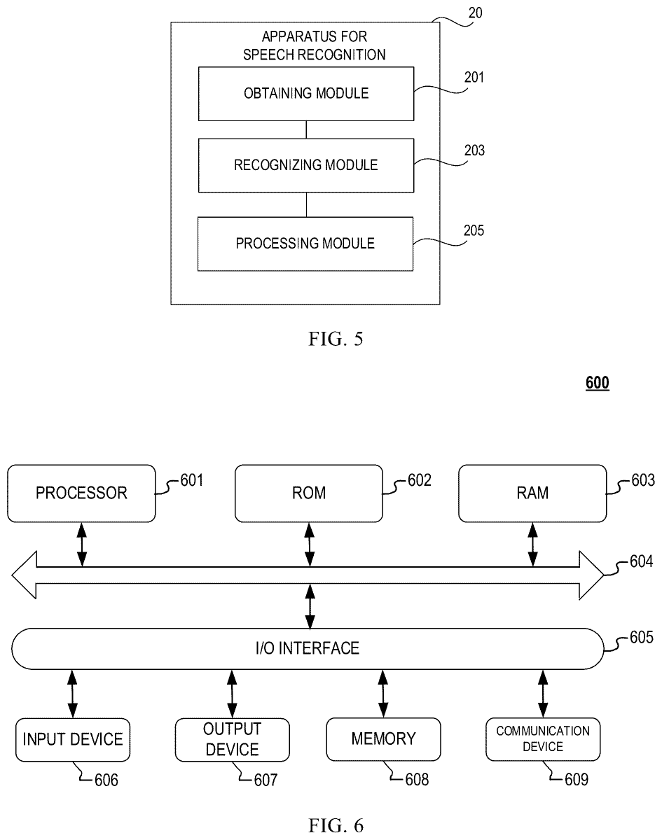

FIG. 5 is a block diagram of an apparatus for speech recognition according to an example embodiment of the present disclosure. Referring to FIG. 5, the apparatus 20 comprises an obtaining module 201 and a recognizing module 203.

The obtaining module 201 is configured to obtain a target speech signal comprising a plurality of languages to be recognized;

The recognizing module 203 is configured to recognize semantics of the target speech signal through a speech recognition model fusing sparse sub-networks of various languages; and the sparse sub-network being obtained by performing a parameter-pruning processing on a multi-language pre-trained model, the multi-language pre-trained model being obtained by training based on a speech signal comprising the plurality of languages.

The apparatus 20 further comprises a processing module 205.

Optionally, the processing module 205 is configured to obtain a speech signal comprising the plurality of languages as a training sample;
obtain the multi-language pre-trained model by training based on the training sample, the multi-language pre-trained model being used for speech recognition;
perform a parameter-pruning processing on the multi-language pre-trained model for the plurality of languages respectively to obtain a sparse sub-network corresponding to a respective language;
update parameters of each of the sparse sub-networks by performing multi-language adaptive pre-training on each of the sparse sub-networks via a corresponding language, to obtain a shared parameter and an exclusive parameter between the sparse sub-networks; and
obtain the speech recognition model fusing the sparse sub-networks of various languages based on the shared parameter and the exclusive parameter.

Optionally, the processing module 205 is further configured to convert the speech signal into a plurality of low-dimensional signal frames, the signal frame being a speech representation signal with a fixed duration;
mask any frame of the plurality of signal frames to obtain a masked speech signal;
input the masked speech signal into an initial multi-language pre-trained model for semantic learning, to predict the masked signal frame; if the predicted masked signal frame is consistent with an actual masked signal frame, determine that the prediction is correct and updating a parameter of the initial multi-language pre-trained model; and
repeat the step of updating the parameter of the initial multi-language pre-trained model to obtain the multi-language pre-trained model.

Optionally, the processing module 205 is further configured to perform up-sampling on a training sample in a language with the number of samples less than a first threshold, to expand, in the sampled data, the number of training samples in the language with the number of samples less than the first threshold; and
perform uniform sampling on a language with the number of samples higher than a second threshold.

Optionally, the processing module 205 is further configured to perform, based on a lottery assumption manner, the parameter-pruning processing on the multi-language pre-trained model for the plurality of languages respectively to obtain the sparse sub-network corresponding to the respective language; and
perform, based on a Taylor unfolding manner, the parameter-pruning processing on the multi-language pre-trained model for the plurality of languages respectively to obtain the sparse sub-network corresponding to the respective language.

Optionally, the processing module 205 is further configured to train the multi-language pre-trained model by using the speech signal of each language as a training sample;
obtain all parameters of the multi-language pre-trained model corresponding to each language;
construct a parameter matrix based on the parameters;
construct a mask matrix corresponding to the parameter matrix;
obtain an absolute value of each parameter in the parameter matrix;
crop the parameter of a predetermined proportion based on a magnitude of the absolute value; and
set a masking state of the cropped parameter at a corresponding position in the mask matrix to a first value and the masking states of the remaining positions to a second value.

Optionally, the processing module 205 is further configured to train the multi-language pre-trained model by using the speech signal of each language as a training sample;
obtain all parameters of the multi-language pre-trained model corresponding to each language;
predict, after unfolding the parameters by a first-order Taylor, a loss value caused to the multi-language pre-trained model after respective parameter has been cropped; and
crop the parameters of a predetermined proportion based on a magnitude of the loss value.

Reference is made below to FIG. 6, which shows a structural schematic diagram of an electronic device (e.g., the terminal device or server of FIG. 1) 600 suitable for implementing embodiments of the present disclosure. The terminal device in embodiments of the present disclosure may comprise, but is not limited to, mobile terminals such as a mobile phone, a laptop computer, a digital broadcast receiver, a personal digital assistant (PDA), a PAD (tablet computer), a portable multimedia player (PMP), a vehicle-mounted terminal (e.g., a vehicle navigation terminal), and the like, as well as stationary terminals such as digital TVs, desktop computers and the like. The electronic device illustrated in FIG. 6 is merely an example and should not impose any limitation on the functions and scope of use of the embodiments of the present disclosure.

As shown in FIG. 6, the electronic device 600 may comprise a processor (e.g., a central processor, a graphics processor, etc.) 601 that may perform various appropriate actions and processes in accordance with a program stored in a read-only memory (ROM) 602 or loaded from a memory 608 into a random access memory (RAM) 603. Also stored in the RAM 603 are various programs and data necessary for the operation of the electronic device 600. The processor 601, the ROM 602, and the RAM 603 are connected to each other via a bus 604. An input/output (I/O) interface 605 is also connected to the bus 604.

Typically, the following devices may be connected to the I/O interface 605: an input device 606 comprising, for example, a touch screen, a touch pad, a keyboard, a mouse, a camera, a microphone, an accelerometer, a gyroscope, and the like; an output device 607 comprising, for example, a Liquid Crystal Display (LCD), a loudspeaker, a vibrator, and the like; a memory 608 comprising, for example, a magnetic tape, a hard disk, and the like; and a communication device 609. The communication device 609 may allow the electronic device 600 to communicate wirelessly or wiredly with other devices to exchange data. While FIG. 6 illustrates electronic device 600 with various apparatuses, it should be understood that it is not required to implement or have all of the illustrated apparatuses. More or fewer apparatuses may alternatively be implemented or possessed.

In particular, according to embodiments of the present disclosure, the process described above with reference to the flowchart may be implemented as a computer software program. For example, embodiments of the present disclosure include a computer program product comprising a computer program carried on a non-transitory computer-readable medium, the computer program comprising program code for performing the method shown in the flowchart. In such embodiments, the computer program may be downloaded and installed from a network via the communication device 609, or from the memory 608, or from the ROM 602. At the time the computer program is executed by the processor 601, it performs the above-described functions defined in the methods of embodiments of the present disclosure.

It should be noted that the computer-readable medium in the present disclosure may be a computer-readable signal medium or a computer-readable storage medium, or any combination thereof. A computer-readable storage medium may be, for example, but not limited to, an electronic, magnetic, optical, electromagnetic, infrared, or semiconductor system, apparatus, or appliance, or any suitable combination of the foregoing. More specific examples of the computer-readable storage medium may comprise, but are not limited to, an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the present disclosure, a computer-readable storage medium may be any tangible medium that can contain or store a program for use by or in connection with an instruction execution system, apparatus, or appliance. While in the present disclosure, a computer-readable signal medium may comprise a propagated data signal with computer-readable program code embodied therein, for example, in baseband or as part of a carrier wave. Such a propagated signal may take any of a variety of forms, comprising, but not limited to, electro-magnetic, optical, or any suitable combination thereof. A computer-readable signal medium may also be any computer-readable storage medium that is not a computer-readable storage medium and that can communicate, propagate, or transport a program for use by or in connection with an instruction execution system, apparatus, or device. Program code embodied on a computer-readable medium may be transmitted using any appropriate medium, comprising, but not limited to, wireline, optical fiber cable, Radio Frequency (RF), etc., or any suitable combination of the foregoing.

In some implementations, the terminals, servers may communicate with any currently known or future developed network protocol such as HyperText Transfer Protocol (HTTP) and may be interconnected with digital data communications (e.g., communication networks) of any form or medium. Examples of communication networks comprise Local Area Networks (LANs), Wide Area Networks (WANs), inter-networks (e.g., the Internet), and end-to-end networks (e.g., ad hoc end-to-end networks), as well as any currently known or future-developed networks.

The above-described computer-readable medium may be included in the above-described electronic device; or it may exist separately and not be assembled into that electronic device.

The computer-readable medium carries one or more programs, which, when the one or more programs are executed by the electronic device, causes the electronic device: obtaining a target speech signal comprising a plurality of languages to be recognized; recognizing semantics of the target speech signal through a speech recognition model fusing sparse sub-networks of various languages; and the sparse sub-network being obtained by performing a parameter-pruning processing on a multi-language pre-trained model, the multi-language pre-trained model being obtained by training based on a speech signal comprising the plurality of languages.

Computer program code for carrying out operations for aspects of the present disclosure may be written in any combination of one or more programming languages, comprising, but not limited to, an object oriented programming language such as Java, Smalltalk, C++ or the like and conventional procedural programming languages, such as the ‘C’ programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, comprising a local area network (LAN) or a wide area network (WAN), or the connection may be made to an external computer (for example, through the Internet using an Internet Service Provider).

The flowchart and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The modules involved in the embodiments of the present disclosure may be implemented by software or by hardware. The name of a module does not constitute a limitation to the module itself in a certain case.

The functions described herein above may be performed, at least in part, by one or more hardware logic components. For example, example types of hardware logic components that can be used include, without limitation, Field Programmable Gate Arrays (FPGAs), Application Specific Integrated Circuit (ASICs), Application Specific Standard Products (ASSPs), System on a chip (SOC), Complex Programmable Logic Devices (CPLDs), etc.

In the context of this disclosure, a machine-readable storage medium may be tangible media that may contain or store a program for use by or in connection with an instruction execution system, apparatus, or device. The machine-readable storage medium may be a machine-readable signal medium or a machine-readable storage medium. A machine-readable storage medium may include, but is not limited to, an electronic, magnetic, optical, electromagnetic, infrared, or semiconductor system, apparatus, or device, or any suitable combination of the foregoing. More specific examples of machine-readable storage media would include an electrical connection based on one or more wires, a portable computer diskette, a hard disk, a random access memory (RAM), a read-only memory (ROM), an erasable programmable read-only memory (EPROM or Flash memory), an optical fiber, a compact disc read-only memory (CD-ROM), an optical storage device, a magnetic storage device, or any suitable combination of the foregoing.

According to one or more embodiments of the present disclosure, Example 1 provides a method of speech recognition, comprising: obtaining a target speech signal comprising a plurality of languages to be recognized;
recognizing semantics of the target speech signal through a speech recognition model fusing sparse sub-networks of various languages; and
the sparse sub-network being obtained by performing a parameter-pruning processing on a multi-language pre-trained model, the multi-language pre-trained model being obtained by training based on a speech signal comprising the plurality of languages.

According to one or more embodiments of the present disclosure, Example 2 provides the method of Example 1, wherein a method of training the speech recognition model comprises:
obtaining a speech signal comprising the plurality of languages as a training sample;
obtaining the multi-language pre-trained model by training based on the training sample, the multi-language pre-trained model being used for speech recognition;
performing a parameter-pruning processing on the multi-language pre-trained model for the plurality of languages respectively to obtain a sparse sub-network corresponding to a respective language;
updating parameters of each of the sparse sub-networks by performing multi-language adaptive pre-training on each of the sparse sub-networks via a corresponding language, to obtain a shared parameter and an exclusive parameter between the sparse sub-networks; and
obtaining the speech recognition model fusing the sparse sub-networks of various languages based on the shared parameter and the exclusive parameter.

According to one or more embodiments of the present disclosure, example 3 provides the method of example 2, wherein the step of obtaining the multi-language pre-trained model by training based on the training sample comprises:
converting the speech signal into a plurality of low-dimensional signal frames, the signal frame being a speech representation signal with a fixed duration;
masking any frame of the plurality of signal frames to obtain a masked speech signal;
inputting the masked speech signal into an initial multi-language pre-trained model for semantic learning, to predict the masked signal frame; if the predicted masked signal frame is consistent with an actual masked signal frame, determining that the prediction is correct and updating a parameter of the initial multi-language pre-trained model; and
repeating the step of updating the parameter of the initial multi-language pre-trained model to obtain the multi-language pre-trained model.

According to one or more embodiments of the present disclosure, Example 4 provides the method of Example 3, wherein the step of obtaining the multi-language pre-trained model by training based on the training sample further comprises:
performing up-sampling on a training sample in a language with the number of samples less than a first threshold, to expand, in the sampled data, the number of training samples in the language with the number of samples less than the first threshold; and
performing uniform sampling on a language with the number of samples higher than a second threshold.

According to one or more embodiments of the present disclosure, example 5 provides the method of example 2, wherein the step of performing a parameter-pruning processing on the multi-language pre-trained model for the plurality of languages respectively to obtain a sparse sub-network corresponding to a respective language comprises:
performing, based on a lottery assumption manner, the parameter-pruning processing on the multi-language pre-trained model for the plurality of languages respectively to obtain the sparse sub-network corresponding to the respective language; and
performing, based on a Taylor unfolding manner, the parameter-pruning processing on the multi-language pre-trained model for the plurality of languages respectively to obtain the sparse sub-network corresponding to the respective language.

According to one or more embodiments of the present disclosure, example 6 provides the method of example 5, wherein the step of performing, based on a lottery assumption manner, the parameter-pruning processing on the multi-language pre-trained model for the plurality of languages respectively to obtain the sparse sub-network corresponding to the respective language comprises:
training the multi-language pre-trained model by using the speech signal of each language as a training sample;
obtaining all parameters of the multi-language pre-trained model corresponding to each language;
constructing a parameter matrix based on the parameters;
constructing a mask matrix corresponding to the parameter matrix;
obtaining an absolute value of each parameter in the parameter matrix;
cropping the parameter of a predetermined proportion based on a magnitude of the absolute value; and
setting a masking state of the cropped parameter at a corresponding position in the mask matrix to a first value and the masking states of the remaining positions to a second value.

According to one or more embodiments of the present disclosure, example 7 provides the method of example 5, wherein the step of performing, based on a Taylor unfolding manner, the parameter-pruning processing on the multi-language pre-trained model for the plurality of languages respectively to obtain the sparse sub-network corresponding to the respective language comprises:
training the multi-language pre-trained model by using the speech signal of each language as a training sample;
obtaining all parameters of the multi-language pre-trained model corresponding to each language;
predicting, after unfolding the parameters by a first-order Taylor, a loss value caused to the multi-language pre-trained model after respective parameter has been cropped; and
cropping the parameters of a predetermined proportion based on a magnitude of the loss value.

According to one or more embodiments of the disclosure, example 8 provides the method of example 7, wherein the formula of predicting a loss value caused to the multi-language pre-trained model after respective parameter has been cropped comprises:

|g²w²|

wherein g is a gradient of the parameter, w is a weight of the parameter.

According to one or more embodiments of the present disclosure, Example 9 provides an apparatus for speech recognition, comprising: an obtaining module configured to obtain a target speech signal comprising a plurality of languages to be recognized;
a recognizing module configured to recognize semantics of the target speech signal through a speech recognition model fusing sparse sub-networks of various languages; and
the sparse sub-network being obtained by performing a parameter-pruning processing on a multi-language pre-trained model, the multi-language pre-trained model being obtained by training based on a speech signal comprising the plurality of languages.

According to one or more embodiments of the present disclosure, Example 10 provides a computer-readable medium having a computer program stored thereon, wherein the computer program, when executed by a processor, implements the steps of the method of speech recognition.

According to one or more embodiments of the present disclosure, Example 11 provides an electronic device, comprising: a memory having a computer program stored thereon; and a processor for executing the computer program in the memory to implement the steps of the method of speech recognition.

According to one or more embodiments of the present disclosure, Example 12 provides a computer program product comprising a computer program carried on a computer-readable medium, program code comprised in the computer program being for implementing the steps of the method of speech recognition.

According to one or more embodiments of the present disclosure, Example 13 provides a computer program, which, when executed by a processor, implements the steps of the method of speech recognition.

The foregoing description is merely illustrative of the preferred embodiments of the present disclosure and of the technical principles applied thereto, as will be appreciated by those skilled in the art, The disclosure of the present disclosure is not limited to the technical solution formed by the specific combination of the described technical features, At the same time, it should also cover other technical solutions formed by any combination of the described technical features or equivalent features thereof without departing from the described disclosed concept. For example, the above features and technical features having similar functions disclosed in the present disclosure (but not limited thereto) are replaced with each other to form a technical solution.

In addition, while operations are depicted in a particular order, this should not be understood as requiring that the operations be performed in the particular order shown or in sequential order. Multitasking and parallel processing may be advantageous in certain circumstances. Likewise, while several specific implementation details are included in the above discussion, these should not be construed as limiting the scope of the present disclosure. Certain features that are described in the context of separate embodiments can also be implemented in combination in a single embodiment. Conversely, various features that are described in the context of a single embodiment can also be implemented in multiple embodiments separately or in any suitable subcombination.

Although the subject matter has been described in language specific to structural features and/or methodological acts, it is to be understood that the subject matter defined in the appended claims is not necessarily limited to the specific features or acts described above. Rather, the specific features and acts described above are merely example forms of implementing the claims. With respect to the apparatus in the foregoing embodiments, the specific manner in which the modules execute the operations has been described in detail in the embodiments of the method and is not described in detail herein.

1. A method of speech recognition, comprising:
obtaining a target speech signal comprising a plurality of languages to be recognized;
recognizing semantics of the target speech signal through a speech recognition model fusing sparse sub-networks of various languages; and
the sparse sub-network being obtained by performing a parameter-pruning processing on a multi-language pre-trained model, the multi-language pre-trained model being obtained by training based on a speech signal comprising the plurality of languages.

2. The method of claim 1, wherein a method of training the speech recognition model comprises:
obtaining a speech signal comprising the plurality of languages as a training sample;
obtaining the multi-language pre-trained model by training based on the training sample, the multi-language pre-trained model being used for speech recognition;
performing a parameter-pruning processing on the multi-language pre-trained model for the plurality of languages respectively to obtain a sparse sub-network corresponding to a respective language;
updating parameters of each of the sparse sub-networks by performing multi-language adaptive pre-training on each of the sparse sub-networks via a corresponding language, to obtain a shared parameter and an exclusive parameter between the sparse sub-networks; and
obtaining the speech recognition model fusing the sparse sub-networks of various languages based on the shared parameter and the exclusive parameter.

3. The method of claim 2, wherein obtaining the multi-language pre-trained model by training based on the training sample comprises:
converting the speech signal into a plurality of low-dimensional signal frames, the signal frame being a speech representation signal with a fixed duration;
masking signal frame of the plurality of signal frames to obtain a masked speech signal;
inputting the masked speech signal into an initial multi-language pre-trained model for semantic learning, to predict the masked signal frame; if the predicted masked signal frame is consistent with an actual masked signal frame, determining that the prediction is correct and updating a parameter of the initial multi-language pre-trained model; and
repeating the step of updating the parameter of the initial multi-language pre-trained model to obtain the multi-language pre-trained model.

4. The method of claim 3, wherein obtaining the multi-language pre-trained model by training based on the training sample further comprises:
performing up-sampling on a training sample in a language with the number of samples less than a first threshold, to expand, in the sampled data, the number of training samples in the language with the number of samples less than the first threshold; and
performing uniform sampling on a language with the number of samples higher than a second threshold.

5. The method claim 2, wherein performing a parameter-pruning processing on the multi-language pre-trained model for the plurality of languages respectively to obtain a sparse sub-network corresponding to a respective language comprises:
performing, based on a lottery assumption manner, the parameter-pruning processing on the multi-language pre-trained model for the plurality of languages respectively to obtain the sparse sub-network corresponding to the respective language; and
performing, based on a Taylor unfolding manner, the parameter-pruning processing on the multi-language pre-trained model for the plurality of languages respectively to obtain the sparse sub-network corresponding to the respective language.

6. The method of claim 5, wherein performing, based on a lottery assumption manner, the parameter-pruning processing on the multi-language pre-trained model for the plurality of languages respectively to obtain the sparse sub-network corresponding to the respective language comprises:
training the multi-language pre-trained model by using the speech signal of each language as a training sample;
obtaining all parameters of the multi-language pre-trained model corresponding to each language;
constructing a parameter matrix based on the parameters;
constructing a mask matrix corresponding to the parameter matrix;
obtaining an absolute value of each parameter in the parameter matrix;
cropping the parameter of a predetermined proportion based on a magnitude of the absolute value; and
setting a masking state of the cropped parameter at a corresponding position in the mask matrix to a first value and the masking states of the remaining positions to a second value.

7. The method of claim 5, wherein performing, based on a Taylor unfolding manner, the parameter-pruning processing on the multi-language pre-trained model for the plurality of languages respectively to obtain the sparse sub-network corresponding to the respective language comprises:
training the multi-language pre-trained model by using the speech signal of each language as a training sample;
obtaining all parameters of the multi-language pre-trained model corresponding to each language;
predicting, after unfolding the parameters by a first-order Taylor, a loss value caused to the multi-language pre-trained model after respective parameter has been cropped; and
cropping the parameters of a predetermined proportion based on a magnitude of the loss value.

8. (canceled)

9. A non-transitory computer-readable medium having a computer program stored thereon, wherein the computer program, when executed by a processor, implement the acts comprising:
obtaining a target speech signal comprising a plurality of languages to be recognized;
recognizing semantics of the target speech signal through a speech recognition model fusing sparse sub-networks of various languages; and
the sparse sub-network being obtained by performing a parameter-pruning processing on a multi-language pre-trained model, the multi-language pre-trained model being obtained by training based on a speech signal comprising the plurality of languages.

10. An electronic device, comprising:
a memory having a computer program stored thereon; and
a processor for executing the computer program in the memory to implement the acts comprising:
obtaining a target speech signal comprising a plurality of languages to be recognized;
recognizing semantics of the target speech signal through a speech recognition model fusing sparse sub-networks of various languages; and
the sparse sub-network being obtained by performing a parameter-pruning processing on a multi-language pre-trained model, the multi-language pre-trained model being obtained by training based on a speech signal comprising the plurality of languages.

11. (canceled)

12. (canceled)

13. The device of claim 10, wherein training the speech recognition model comprises:
obtaining a speech signal comprising the plurality of languages as a training sample;
obtaining the multi-language pre-trained model by training based on the training sample, the multi-language pre-trained model being used for speech recognition;
performing a parameter-pruning processing on the multi-language pre-trained model for the plurality of languages respectively to obtain a sparse sub-network corresponding to a respective language;
updating parameters of each of the sparse sub-networks by performing multi-language adaptive pre-training on each of the sparse sub-networks via a corresponding language, to obtain a shared parameter and an exclusive parameter between the sparse sub-networks; and
obtaining the speech recognition model fusing the sparse sub-networks of various languages based on the shared parameter and the exclusive parameter.

14. The device of claim 13, wherein obtaining the multi-language pre-trained model by training based on the training sample comprises:
converting the speech signal into a plurality of low-dimensional signal frames, the signal frame being a speech representation signal with a fixed duration;
masking signal frame of the plurality of signal frames to obtain a masked speech signal;
inputting the masked speech signal into an initial multi-language pre-trained model for semantic learning, to predict the masked signal frame; if the predicted masked signal frame is consistent with an actual masked signal frame, determining that the prediction is correct and updating a parameter of the initial multi-language pre-trained model; and
repeating the step of updating the parameter of the initial multi-language pre-trained model to obtain the multi-language pre-trained model.

15. The device of claim 14, wherein obtaining the multi-language pre-trained model by training based on the training sample further comprises:
performing up-sampling on a training sample in a language with the number of samples less than a first threshold, to expand, in the sampled data, the number of training samples in the language with the number of samples less than the first threshold; and
performing uniform sampling on a language with the number of samples higher than a second threshold.

16. The device of claim 13, wherein performing a parameter-pruning processing on the multi-language pre-trained model for the plurality of languages respectively to obtain a sparse sub-network corresponding to a respective language comprises:
performing, based on a lottery assumption manner, the parameter-pruning processing on the multi-language pre-trained model for the plurality of languages respectively to obtain the sparse sub-network corresponding to the respective language; and
performing, based on a Taylor unfolding manner, the parameter-pruning processing on the multi-language pre-trained model for the plurality of languages respectively to obtain the sparse sub-network corresponding to the respective language.

17. The device of claim 16, wherein performing, based on a lottery assumption manner, the parameter-pruning processing on the multi-language pre-trained model for the plurality of languages respectively to obtain the sparse sub-network corresponding to the respective language comprises:
training the multi-language pre-trained model by using the speech signal of each language as a training sample;
obtaining all parameters of the multi-language pre-trained model corresponding to each language;
constructing a parameter matrix based on the parameters;
constructing a mask matrix corresponding to the parameter matrix;
obtaining an absolute value of each parameter in the parameter matrix;
cropping the parameter of a predetermined proportion based on a magnitude of the absolute value; and
setting a masking state of the cropped parameter at a corresponding position in the mask matrix to a first value and the masking states of the remaining positions to a second value.

18. The device of claim 16, wherein performing, based on a Taylor unfolding manner, the parameter-pruning processing on the multi-language pre-trained model for the plurality of languages respectively to obtain the sparse sub-network corresponding to the respective language comprises:
training the multi-language pre-trained model by using the speech signal of each language as a training sample;
obtaining all parameters of the multi-language pre-trained model corresponding to each language;
predicting, after unfolding the parameters by a first-order Taylor, a loss value caused to the multi-language pre-trained model after respective parameter has been cropped; and
cropping the parameters of a predetermined proportion based on a magnitude of the loss value.

19. The medium of claim 9, wherein training the speech recognition model comprises:
obtaining a speech signal comprising the plurality of languages as a training sample;
obtaining the multi-language pre-trained model by training based on the training sample, the multi-language pre-trained model being used for speech recognition;
performing a parameter-pruning processing on the multi-language pre-trained model for the plurality of languages respectively to obtain a sparse sub-network corresponding to a respective language;
updating parameters of each of the sparse sub-networks by performing multi-language adaptive pre-training on each of the sparse sub-networks via a corresponding language, to obtain a shared parameter and an exclusive parameter between the sparse sub-networks; and
obtaining the speech recognition model fusing the sparse sub-networks of various languages based on the shared parameter and the exclusive parameter.

20. The medium of claim 19, wherein obtaining the multi-language pre-trained model by training based on the training sample comprises:
converting the speech signal into a plurality of low-dimensional signal frames, the signal frame being a speech representation signal with a fixed duration;
masking signal frame of the plurality of signal frames to obtain a masked speech signal;
inputting the masked speech signal into an initial multi-language pre-trained model for semantic learning, to predict the masked signal frame; if the predicted masked signal frame is consistent with an actual masked signal frame, determining that the prediction is correct and updating a parameter of the initial multi-language pre-trained model; and
repeating the step of updating the parameter of the initial multi-language pre-trained model to obtain the multi-language pre-trained model.

21. The medium of claim 20, wherein obtaining the multi-language pre-trained model by training based on the training sample further comprises:
performing up-sampling on a training sample in a language with the number of samples less than a first threshold, to expand, in the sampled data, the number of training samples in the language with the number of samples less than the first threshold; and
performing uniform sampling on a language with the number of samples higher than a second threshold.

22. The medium of claim 19, wherein performing a parameter-pruning processing on the multi-language pre-trained model for the plurality of languages respectively to obtain a sparse sub-network corresponding to a respective language comprises:
performing, based on a lottery assumption manner, the parameter-pruning processing on the multi-language pre-trained model for the plurality of languages respectively to obtain the sparse sub-network corresponding to the respective language; and
performing, based on a Taylor unfolding manner, the parameter-pruning processing on the multi-language pre-trained model for the plurality of languages respectively to obtain the sparse sub-network corresponding to the respective language.

23. The medium of claim 22, wherein performing, based on a lottery assumption manner, the parameter-pruning processing on the multi-language pre-trained model for the plurality of languages respectively to obtain the sparse sub-network corresponding to the respective language comprises:
training the multi-language pre-trained model by using the speech signal of each language as a training sample;
obtaining all parameters of the multi-language pre-trained model corresponding to each language;
constructing a parameter matrix based on the parameters;
constructing a mask matrix corresponding to the parameter matrix;
obtaining an absolute value of each parameter in the parameter matrix;
cropping the parameter of a predetermined proportion based on a magnitude of the absolute value; and
setting a masking state of the cropped parameter at a corresponding position in the mask matrix to a first value and the masking states of the remaining positions to a second value.
